(19) United States
(12) Patent Application Publication
(10) Pub. No.: US 2025/0172184 A1
(43) Pub. Date: May 29, 2025

(54) NESTED CREST-TO-CREST WAVE SPRING

(71) Applicant: SMALLEY STEEL RING COMPANY, Lake Zurich, IL (US)

(72) Inventor: Walter ZABINSKI, Lake Zurich, IL (US)

(73) Assignee: SMALLEY STEEL RING COMPANY, Lake Zurich, IL (US)

(21) Appl. No.: 18/962,874

(22) Filed: Nov. 27, 2024

Related U.S. Application Data
(60) Provisional application No. 63/602,864, filed on Nov. 27, 2023.

(51) Int. Cl. F16F 1/32; B21F 35/04

(52) U.S. Cl. CPC F16F 1/328; B21F 35/04

(57) ABSTRACT

A nested crest-to-crest wave spring formed from a single, continuous piece of flat wire by coiling a nested wave spring, then shifting the direction of the coil to form a subsequent nested spring that stacks upon the original nested spring without breaking the wire or using any method to fasten the nested springs together. This process can be repeated to stack multiple nested springs together in a crest-to-crest configuration. This process creates a crest-to-crest wave spring that can withstand increased loading over a crest-to-crest wave spring while providing more deflection than a nested wave spring. These changes in wave direction and the number of stacks can be made to any number to achieve the desired load and/or deflection.

### CROSS REFERENCE TO RELATED APPLICATIONS

This application claims priority to U.S. Provisional Application No. 63/602,864, filed Nov. 27, 2023, and entitled “Nested Crest-to-Crest Wave Spring,” the entirety of which has been incorporated by reference.

### FIELD

This disclosure relates to relates generally to wave springs, and more particularly to a nested crest-to-crest wave spring having improved fatigue and operating characteristics.

### BACKGROUND

It has generally been desired that springs have higher deflections while supporting heavier loads. To enable deflections, single turns of springs are patterned into single turn waves that change their shape (i.e., deflect) under loads. To support heavier loads, multiple single turn waves are nested, i.e., stacked together. One example of conventional nesting is to form parallel waves: for two abutting single turn waves, crests abut with crests and troughs abut with troughs. While such parallel nesting supports heavier loads, it may not necessarily provide a desired level of deflection. For better deflection, crest-to-crest wave springs have been developed where the single turn waves are organized in series: e.g., for two single turn waves one on top of the other, crests of the bottom single turn wave touch peaks of the top single turn wave and peaks of the bottom single turn wave touch crests of the top single turn wave.

To support both heavier loads and higher deflections, interlaced crest-to-crest wave springs have been developed. The interlaced crest-to-crest wave springs generally include two or three individual crest-to-crest spring leaves wound together. While being useful, these type of springs pose manufacturing challenges because multiple leaves have to be aligned and joined. Additionally, operational problems may develop during use: for example, when the springs are repeatedly cycled, an individual turn may move out of alignment due to repeated compressions and expansions.

### SUMMARY

Embodiments disclosed herein describe a nested crest-to-crest wave spring formed from a single, continuous piece of flat wire by coiling a nested wave spring, then shifting the direction of the coil to form a subsequent nested spring that stacks upon the original nested spring without breaking the wire or using any method to fasten the nested springs together. This process can be repeated to stack multiple nested springs together in a crest-to-crest configuration. This process creates a crest-to-crest wave spring that can withstand increased loading over a crest-to-crest wave spring while providing more deflection than a nested wave spring. These changes in wave direction and the number of stacks can be made to any number to achieve the desired load and/or deflection.

In one or more embodiments, a nested crest-to-crest wave spring is provided. The nested crest-to-crest wave spring may comprise a first stack comprising a first set of crests and a first set of troughs. The nested crest-to-crest wave spring may further comprise a second stack comprising a second set of crests and a second set of troughs, at least one of the first set of crests interfacing with a corresponding trough in the second set of troughs, at least one of the first set of troughs interfacing with a corresponding crest in the second set of crests. The nested crest-to-crest wave spring may additionally comprise a turn interconnecting the first stack and the second stack, the first stack, the second stack, and the turn being formed of a single piece (i.e., the same piece) of flat wire.

In one or more embodiments, a method is provided. The method may comprise forming, by winding a flat wire, a first stack comprising a first set of crests and a first set of troughs by winding a flat wire. The method may also comprise forming, by winding the flat wire, a second stack comprising a second set of crests and a second set of troughs, at least one of the first set of crests interfacing with a corresponding trough in the second set of troughs, at least one of the first set of troughs interfacing with a corresponding crest in the second set of crests. The method may additionally comprise forming, by winding the flat wire, a turn interconnecting the first stack and the second stack.

### BRIEF DESCRIPTION OF DRAWINGS

FIG. 1 illustrates the conventional single turn wave spring comprising a single piece of flat wire formed in a waved pattern in a single circumferential turn.

FIG. 2 illustrates a conventional nested spring, which is an expansion on the principle of the single turn wave spring.

FIG. 3 illustrates the crest-to-crest wave spring which is a different expansion of the wave spring concept by coiling a single piece of flat wire in the waved pattern and stacking the waves in series so that the crests of one turn contact the troughs of another.

FIG. 4 illustrates three examples of crest-to-crest wave springs configured to form an interlaced spring shown in FIG. 5.

FIG. 6 illustrates that the ends need to be cut back to form a floating end in an interlaced spring according to the prior art.

FIG. 7 shows a new and improved nested crest-to-crest wave spring, based on the principles disclosed herein.

FIG. 8 illustrates the concept of nested crest-to-crest wave spring by stacking two nested wave springs upon one another.

FIG. 9 is an elevational view of a nested crest-to-crest stack transition, based on principles disclosed herein.

FIG. 10 is an elevational view of the nested crest-to-crest transition with a reverse, left-handed wind, based on the principles disclosed herein.

FIG. 11 is a perspective view of a crest-to-crest wave spring with shim ends based on the principles disclosed herein.

FIG. 12 is a perspective view of a crest-to-crest wave spring with one shim end, based on the principles disclosed herein.

FIG. 13 is an elevational view of a nested crest-to-crest wave spring with shim ends, based on the principles disclosed herein.

FIG. 14 is an elevational view of a nested crest-to-crest wave spring with shims on each terminating end as well as shims in-between the nested spring stacks, based on the principles disclosed herein.

FIG. 15 is a top view of a stack with three waves and another stack with four waves, based on the principles disclosed herein.

FIG. 16 is an elevational view of a nested crest-to-crest wave spring with different number of turns within different stacks, based on the principles disclosed herein.

FIG. 17 is a flowchart of an example method of manufacturing a nested crest-to-crest wave spring, based on the principles disclosed herein.

### DESCRIPTION

Embodiments disclosed herein generally relate to wave springs, and more particularly to a nested crest-to-crest wave spring having improved fatigue and operating characteristics.

The wave pattern used for wave washers has also been used in wave springs such as the single turn wave spring. This is the simplest form of wave spring and provides a relatively lighter load with a relatively smaller deflection. This as well as other wave springs are used in a variety of mechanical applications. Numerous types of wave springs are known in the art and each type has certain advantages and disadvantages, which affect the use of the spring. Other examples of known wave springs are the nested, crest-to-crest, crest-to-crest with shim ends, and interlaced, as detailed further below.

The nested wave spring expands on the single turn wave spring and includes additional revolutions of flat wire that nest or sit parallel to the other turns creating what is essentially a thicker spring without having to coil thicker wire. This allows for much higher loads than the single turn wave spring but still has a relatively smaller deflection similar to that of the single turn wave spring.

Similar to the nested wave spring is a wave ring described in U.S. Pat. No. 4,752,178. As shown in this patent, a wave spring that is particularly suitable for use in retaining ring-type applications, includes one or more flat wire turns that are circularly wound and waved in a sinusoidal-like pattern to provide a wave spring having a pre-desired thickness, which thickness is defined by the total number of spring turns of the spring.

The same sinusoidal-like wave pattern can be expanded upon and has also been incorporated into wave springs that are described in the art as “crest-to-crest” wave springs. Unlike the nested wave spring, the goal is to create a higher possible deflection of the spring. This is done by orienting the individual spring turns in a manner so that successive crest portions of one spring turn abut successive trough portions of each adjacent spring turn. This allows the revolutions of wire to sit in series instead of parallel. This means that the troughs of one revolution of the spring touch the peaks of the revolution below it. The generated loads do not generally exceed those of a nested wave spring, but the possible deflection can increase by the number of revolutions of the crest-to-crest wave spring.

The crest-to-crest wave spring described above may be modified to include opposing, flat end portions that are usually formed by gradually reducing the amplitude and frequency of the waves in the spring turns down to a constant zero level to form opposing flat shim end portions. Such a construction is aptly described in U.S. Pat. No. 4,901,987. Another similar device is the wave spring with a single shim end described in U.S. Pat. No. 6,758,465.

Although useful for most applications, wave springs, may be subject to fatigue during long cycles of loading and unloading as well as repeatedly changing loads. Fatigue may affect the usefulness of wave springs in a detrimental manner because after repeated cycles of even or uneven loading, the operating stress within the spring may increase to a level at which the metal of the spring undergoes failure. One solution to fatigue is to increase the size of the spring cross-section undergoing the loading to reduce the stress created in it under load. In the spring art, this requires using a heavier cross-section of flat wire to form the spring. This solution is not always practical.

An interlaced wave spring as described in U.S. Pat. No. 5,639,074, was created (see FIG. 5) to make a wave spring with high loads and high deflection. Generally, two to three crest-to-crest wave springs, referred to as leaves, are combined to create a single, and essentially thicker spring, in the crest-to-crest configuration. However, the interlaced wave spring has functional challenges that are caused by the different turns of the springs not being attached to one another. Although this type of spring is useful in many applications, the product limitations mean that there are applications not able to use some type of wave spring. The interlaced wave spring does not cycle (compress from one height to another repeatedly) well, even for low cycle requirements. For a triple interlaced design, which incorporates 3 crest-to-crest wave spring leaves wound together to create one interlaced wave spring, the middle spring can work its way out of alignment if the spring is compressed repeatedly from cycling or if the ends of the spring are restricted when the spring is compressed. Friction between the turns and individual interlaced springs also contributes to the interlaced wave spring's limitations.

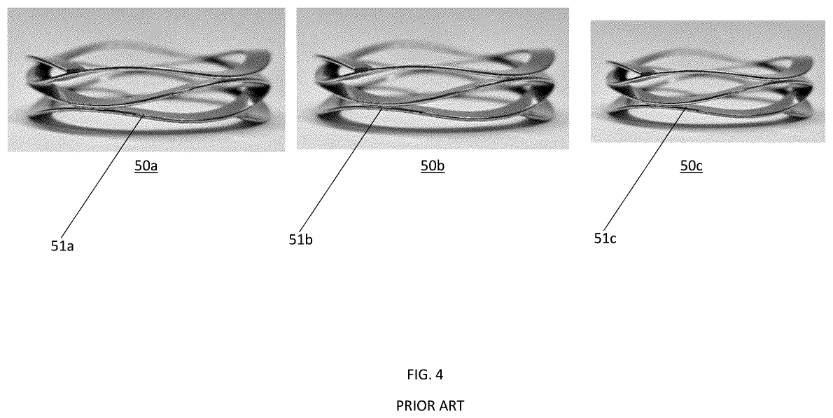

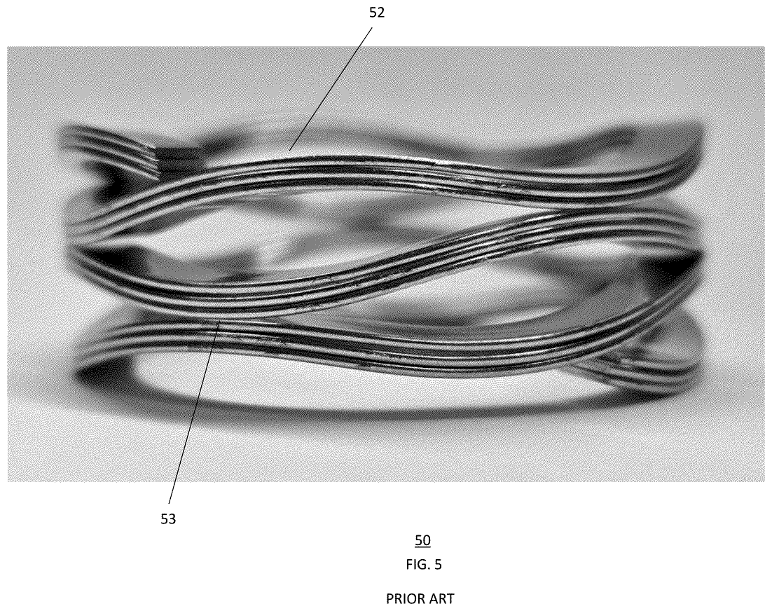

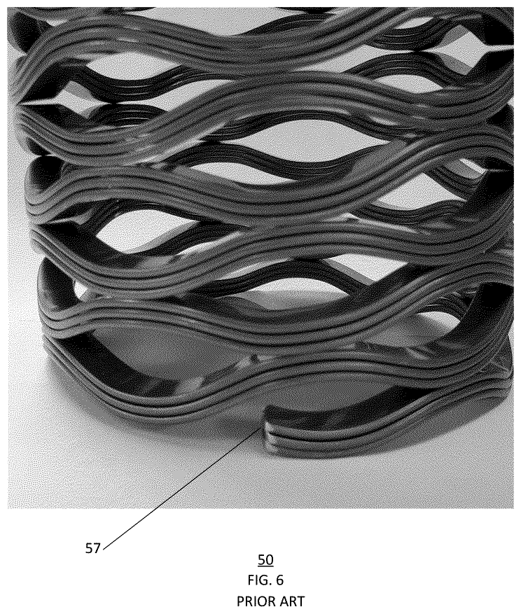

The interlaced wave spring has manufacturing challenges based on the manual process in which they are manufactured. The process for interlacing and cutting the end configuration requires extensive manual labor and has limitations on the level of repeatability. It also cannot be scaled up for high volume production. The individual leaves have a limit to how many can be wound together. The practical limit is generally three crest-to-crest wave spring leaves wound together as a single spring (see FIG. 4 and FIG. 5). Sometimes larger diameter interlaced springs also need floating ends (see FIG. 6) that help with alignment of the spring as well as preventing the ends from contacting and digging into the adjacent turns. The rounded ends are also implemented as a safety feature to eliminate thick, sharp edges and corners that can injure someone handling the spring. These same sharp edges can potentially damage the equipment in which the interlaced wave spring is installed. This all requires additional manual work to properly round the ends and cannot be manufactured automatically.

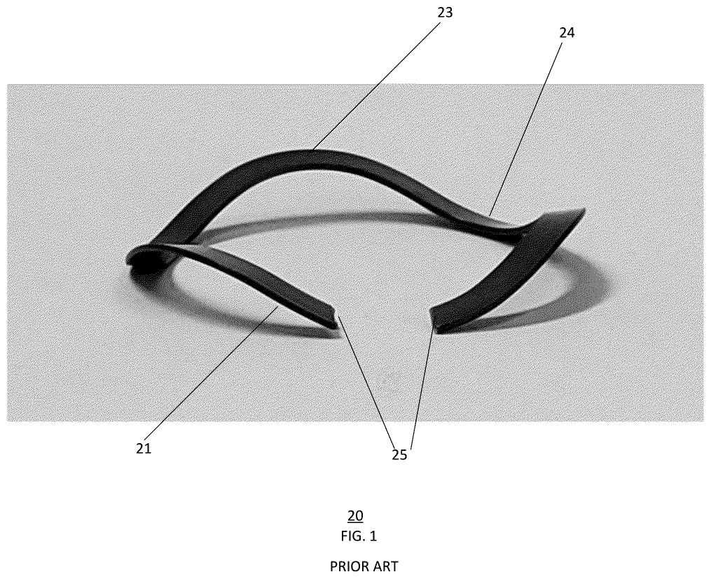

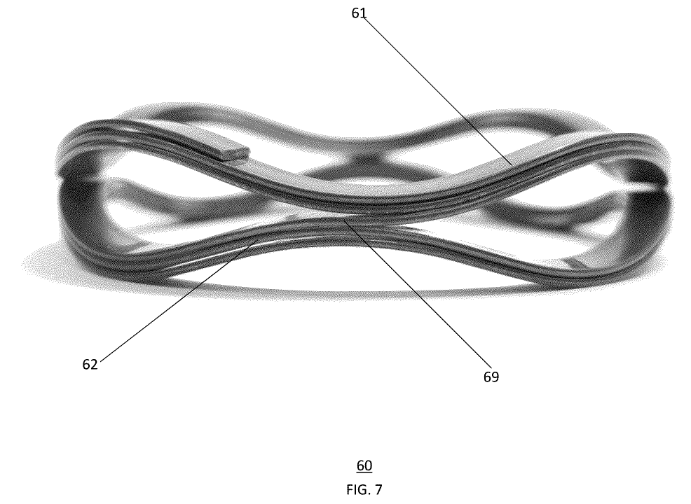

Accordingly, embodiments disclosed herein are directed to improved, nested crest-to-crest wave spring that avoids the aforementioned shortcomings and develops new and improved performance characteristics not previously obtainable with interlaced wave springs. The following description begins with the state of the art as illustrated by FIGS. 1-6 and then illustrates the significant improvement provided by the embodiments disclosed herein in FIGS. 7-17.

FIG. 1 illustrates a conventional single turn wave spring 20 comprising a single piece of flat wire 21 formed in a waved pattern in a single circumferential turn. The spring 20 has successive waves formed from the distinct crest portions 23 and trough portions 24, which follow a substantially sinusoidal wave path in a circular pattern around the longitudinal axis of the spring 20. The thickness of the spring 20 consists of only the thickness of the single piece of flat wire 21. The spring 20 has an operating length, which may generally be the distance between the ends 25 of the spring 20.

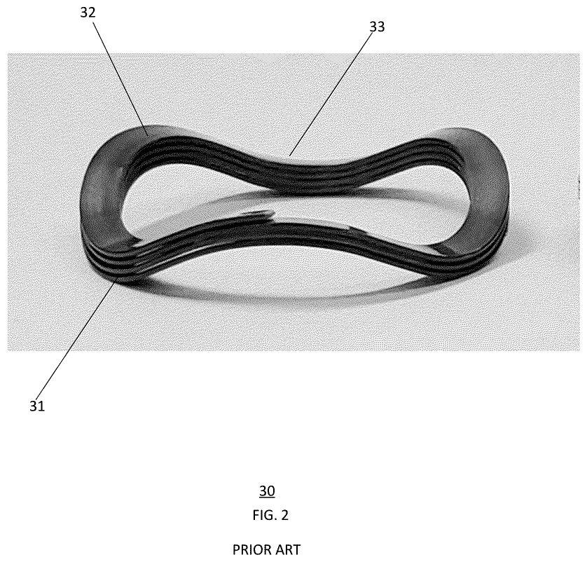

FIG. 2 illustrates a conventional nested spring 30, which is an expansion on the principle of the single turn wave spring 20. The nested spring 30 is formed by continuing the waved coil into multiple turns. The nested spring 30 is formed from a single piece of flat wire 31 which is wound in a generally circular pattern to form a multiturn spring in which the consecutive turns of the spring 30 are closely spaced together and lie adjacent to one another. Each turn is generally parallel to its adjacent turn. The wire is formed into a continuous wave path composed of a series of successive similar wave crests 32 and wave troughs 33. The wave path is continuous and substantially sinusoidal in nature.

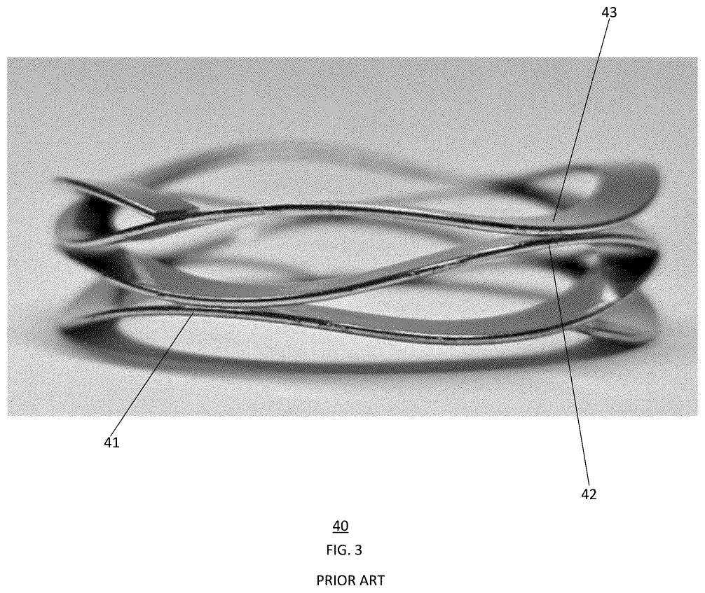

FIG. 3 illustrates the crest-to-crest wave spring 40, which is a different expansion of the wave spring concept by coiling a single piece of flat wire 41 in the waved pattern and stacking the waves in series so that the crests 42 of one turn contact the troughs 43 of another. The crest-to-crest wave spring 40 differs from the nested wave spring 30 where the turns lie parallel to one another. To do this, the waves in the crest-to-crest wave spring 40 need a shift in frequency so that there is a transitional wave that exists between the turns. This is generally referred to in the art as the “half wave.” In the crest-to-crest wave spring 40, the addition of turns is designed to increase deflection and decrease spring rate as opposed to the nested wave spring 30, in which the addition of turns increases in load and spring rate.

FIG. 4 illustrates three examples of crest-to-crest wave springs 50a, 50b, 50c configured to form an interlaced spring 50 shown in FIG. 5. FIG. 4 shows the principle described in U.S. Pat. No. 5,639,074, where the constituent wave springs 50a, 50b, 50c are formed from respective flat wire strips 51a, 51b, 51c, which are spirally wound around their respective spring longitudinal axes to form a series of spring turns. A “spring turn,” as utilized herein refers to a complete 360° revolution around the spring longitudinal axis. Each spring 50a, 50b, 50c is further formed in a wave pattern which defines a wave path extending between the opposite ends of the springs 50a, 50b, 50c. This wave path is preferably introduced during the winding of each spring 50a, 50b, 50c and includes a series of successive similar wave crests and wave troughs. Preferably, the wave path of each spring 50a, 50b, 50c is continuous and sinusoidal in nature throughout its extent between the spring ends. The waves of each spring 50a, 50b, 50c are further formed at a particular frequency, which, as used herein, refers to the number of waves present in each spring turn. Although the constituent wave springs 50a, 50b, 50c and interlaced wave springs shown in FIG. 5 are described herein as having about three waves per turn, it will be understood that such is merely an illustration and the number of waves per turn will be limited only by material and space requirements.

FIG. 5 the interlaced wave spring 50 comprises three constituent wave springs 50a, 50b, 50c (as described in FIG. 4) which are interlaced together. The interlaced wave spring 50 acts as an overall unitary structure. That is, the spring turns of the constituent springs 50a, 50b, 50c may lie adjacent to each other and substantially abut each other for the entire free length of the spring 50 in an uncompressed state. In other words, no significant gaps may occur between the interlaced constituent wave springs 50a, 50b, 50c because the two spring turns are, in effect, “matched” for their entire lengths. In this instant, “significant” means no gaps that exceed 10% of the thickness of the wire that makes up the spring 50. This matching also ensures that the wave crest portions and wave trough portions are aligned together generally at their peaks to form the unitary wave crest portions 52 and wave trough portions 53 of the interlaced wave spring 50.

Due to this interlacing, the thickness of each of the spring turns of the interlaced wave spring 50 is effectively increased by the number N of constituent wave springs. In FIG. 5, this thickness is effectively tripled as a result of three wave springs 50a, 50b, 50c being interlaced together. In effect, the interlaced wave spring 50 provides a way to obtain greater loads on an interlaced spring than on a single spring. The spring characteristics are affected in proportion to the number of interlacings.

Apart from wave frequency and amplitude, it is also desirable, but not required, that the constituent wave springs 50a, 50b, 50c share other equal physical characteristics, such as substantially equal radial widths, thicknesses and materials of construction. This overall equalness of structure of the constituent springs 50a, 50b, 50c assists the interlaced spring 50 in acting as a unitary structure. Equal thicknesses and radial widths of the constituent springs 50a, 50b, 50c may assist in the assembly of the springs by the interlacing thereof which may be done either manually or by machines.

Although the interlaced wave spring 50 is intended to act as a unitary structure, the reality is that the multiple variables that factor into the functioning of the structure is more complex and can, in certain circumstances, be a hindrance. It is known that in some cases the cross sections of wire 51a, 51b, 51c (see FIG. 4) can be prone to misalignment. This is more likely in an interlaced wave spring with three crest-to-crest springs 50a, 50b, 50c as compared to two crest-to-crest springs. Misalignment of the springs can result in improper loading by the spring and improper operation within the application in which the interlaced spring 50 is used.

Additionally, interlaced wave spring 50 pose manufacturing challenges. Multiple springs have to be aligned and joined together. This is typically a manual process. The steps of interlacing the three constituent springs 50a, 50b, 50c is cumbersome and prone to errors.

FIG. 6 illustrates that the ends need to be cut back to form a floating end 57 in an interlaced spring 50. Formation of the floating end 57 may be needed when the cross section of the flat wire is substantially higher. This floating end 57 is generally rounded to remove sharp edges. The purpose of this is to promote better functionality of the interlaced spring 50.

Other operational challenges may develop during use of the interlaced wave spring 50: for example, when the wave spring 50 is repeatedly cycled, individual turns may move out of alignment from the other turns due to repeated compressions and expansions, as well as the diameter expansion and contraction that naturally occurs as a result of the repeated compressions and expansions. This behavior known to this type of wave spring occurs more commonly when the interlaced wave spring 50 cycles too many times and the turns of the individual crest-to-crest wave springs 50a, 50b, 50c do not move as a unitary structure.

FIG. 7 shows a new and improved nested crest-to-crest wave spring 60, based on the principles disclosed herein. The nested crest-to crest wave spring 60 begins with the concept of the nested wave spring 30 (see FIG. 2) to build a higher load capacity. Next, to allow for higher spring deflection, the concept of the crest-to-crest wave spring 50 (see FIG. 5) is implemented. This is done by taking one nested spring, also referred to as a nested stack, as the base of the nested crest-to-crest spring. For this example, that stack is referred to as the lower nested stack 62. The next stack is referred to as the upper nested stack 61 and is formed on top of the lower nested stack 62. The upper nested stack 61 is shifted by either one additional wave or one less wave in the turns 69 of the stack so that the turns of the upper nested stack 61 do not lay adjacent to the turns of the lower nested stack 62. This puts the waves out of sync (e.g., transition of 180 degrees) so that the crests of the lower nested stack 62 will contact the troughs of the upper nested stack 61.

The new and improved crest-to-crest wave spring 60 may offer an increased load carrying capacity, increased fatigue life, and the spring function and flexibility compared to the interlaced wave spring shown in FIG. 6.

The disclosed nested crest-to-crest wave spring 60 provides an unconventional combination of the nested wave spring 20 (see FIG. 2), the crest-to-crest wave spring 50 (see FIG. 5), and the interlaced wave spring 50 (see FIG. 5). Because the nested crest-to-crest wave spring 60 does not require individual crest-to-crest springs 50a, 50b, 50c to be wound together, a singular shim end or multiple shim ends are not prohibited by the spring design or manufacturability.

In one or more embodiments, the wire forming the nested crest-to-crest wave spring 60 may be formed using a metallic wire comprising at least one of carbon steel, 17-7 PH stainless steel, Inconel X-750, or Elgiloy. In one or more embodiments, the wire forming the nested crest-to-crest wave spring 60 may be formed using a non-metallic wire. However, the use of metallic and non-metallic wires are just examples and should not be considered limiting. Any kind of material may be used form the nested crest-to-crest wave spring 60.

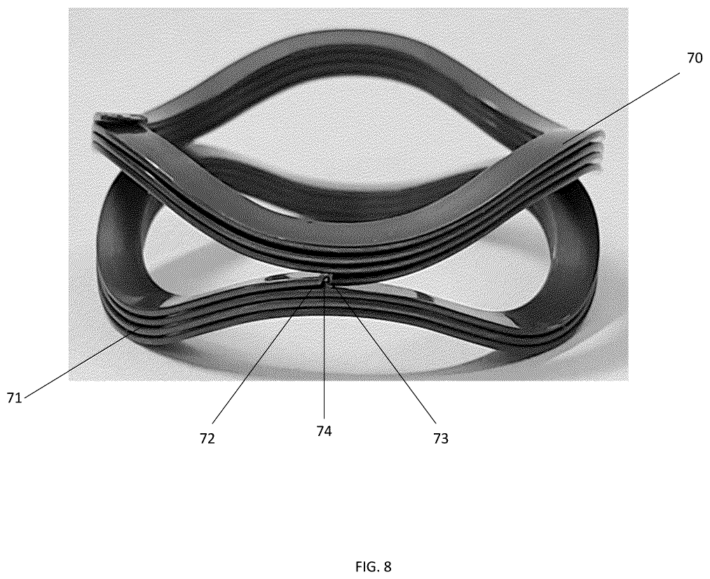

FIG. 8 illustrates the concept of a nested crest-to-crest wave spring by stacking two nested wave springs 70, 71 upon one another. Where the gap end 73 of the upper nested stack 70 abuts the gap end 72 of the lower nested stack 71 illustrates the wave transition 74 from one stack to the next. This is for illustration purposes only. The actual wave transition 74 would not be split as the nested crest-to-crest wave spring is formed using a single piece of flat wire. This stacking concept can be repeated as many times as is necessary to achieve the desired spring properties. This principle differs from a crest-to-crest wave spring 40 in that a crest-to-crest wave spring 40 always has a half wave that transitions into the adjacent turn whereas the nested crest-to-crest will have one full wave extra or one full wave less in the transitional turn to accommodate the redirection of the wave that creates the transition between the nested stacks 70, 71.

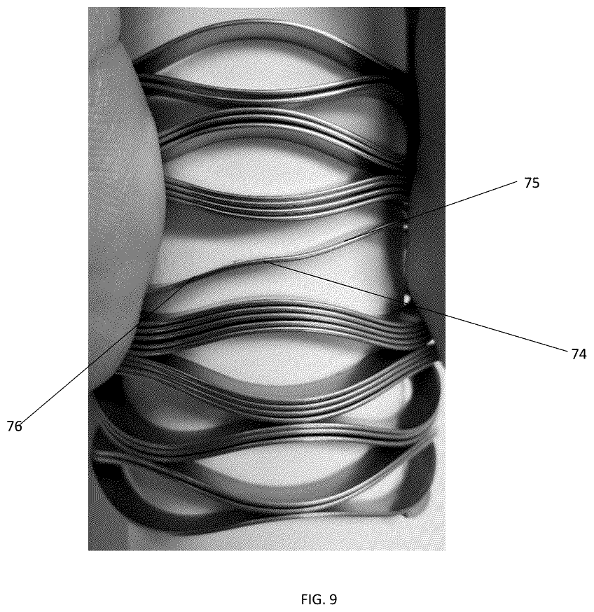

FIG. 9 is an elevational view of a nested crest-to-crest stack transition 74, based on principles disclosed herein. As shown, the transition 74 is from a first wave 75 to a second wave 76. The shown nested crest-to-crest wave spring is right-handed wind.

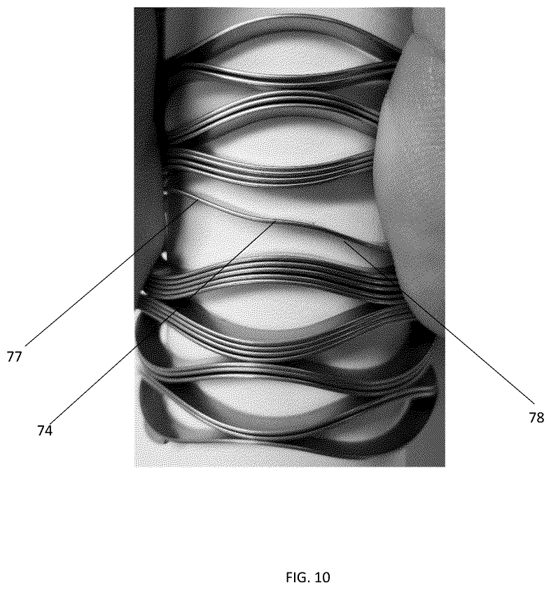

FIG. 10 is an elevational view of the nested crest-to-crest transition 74 with a reverse, left-handed wind, based on the principles disclosed herein. As shown, the transition 74 is from a first wave 77 to a second wave 78.

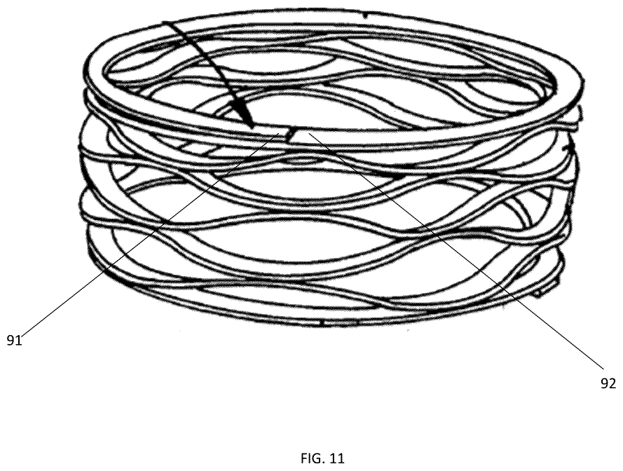

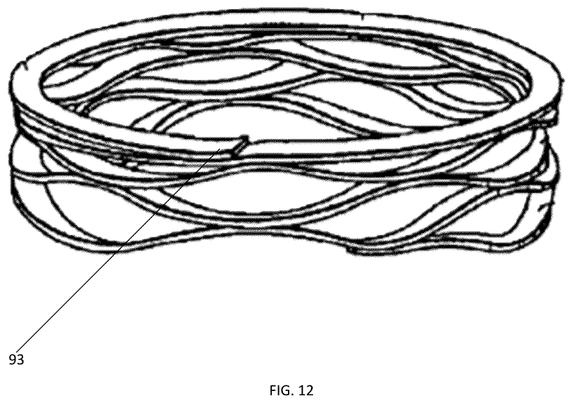

FIG. 11 is a perspective view of a crest-to-crest wave spring with shim ends 91, 92 based on the principles disclosed herein. The shim ends 91, 92 may be added to provide a flat mating surface for the crest-to-crest wave spring. This cannot be done with an interlaced wave spring 50 (see FIG. 5) since the flats on the ends prevent the constituent crest-to-crest leaves 50a, 50b, 50c from being wound together. Similar to the standard crest-to-crest wave spring with shim ends 80, there can be any combination of flats, including but not limited to, a shim on one end, multiple shims on one end, a shim on both ends, multiple shims on both ends. Some non-limiting examples are shown in FIGS. 12-14.

FIG. 12 is a perspective view of a crest-to-crest wave spring with one shim end 93, based on the principles disclosed herein.

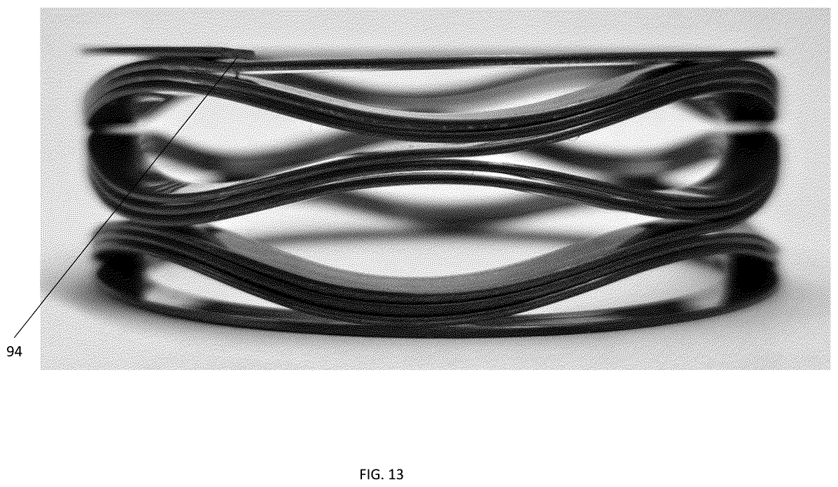

FIG. 13 is an elevational view of a nested crest-to-crest wave spring with shim ends, based on the principles disclosed herein. An example shim end 94 is shown

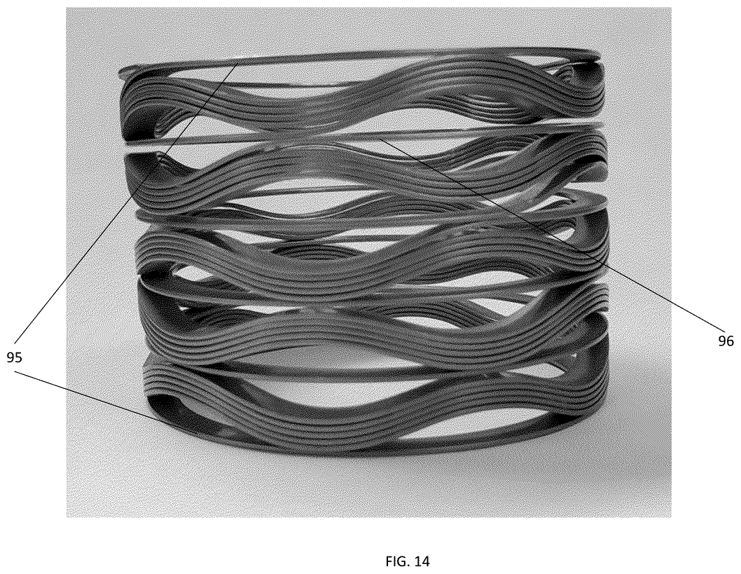

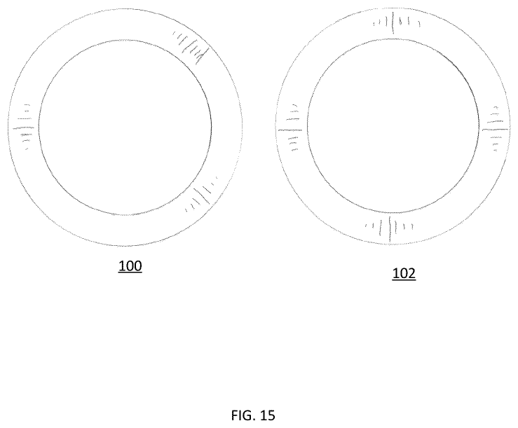

FIG. 14 is an elevational view of a nested crest-to-crest wave spring with shims on each terminating end as well as shims in-between the nested spring stacks, based on the principles disclosed herein. Particularly, shims 95 are the terminating ends, and shim 96 is in between the nested spring stacks. The shims (e.g., shim 96) in between the nested spring stacks are used for support and axial stability between stacks. This is especially needed when one stack has a different number of waves from that of the adjacent stack. In this condition, the crests of one stack and the troughs of the adjacent stack will not line up. An example of this can be seen in FIG. 15.

It should be understood that the configurations shown in FIGS. 12-14 are merely examples and should not be considered limiting. That is, other types of configurations are to be considered within the scope of this disclosure. Additionally, the ends of the nested crest-to-crest do not need to be floating, like a larger interlaced wave spring, regardless of size or cross-section of flat wire. This eliminates the need for the manually cut and rounded floating ends.

FIG. 15 is a top view of a stack 100 with three waves and another stack 102 with four waves, based on the principles disclosed herein. FIG. 15 demonstrates how the waves do not have to line up between stacks. In these cases shims between the stacks are used for axial stability between the stacks (as an example, see FIG. 14) In one or more embodiments, the waves may be identical, i.e., the sinusoidal patterns formed by the stacks 100, 102 may be identical.

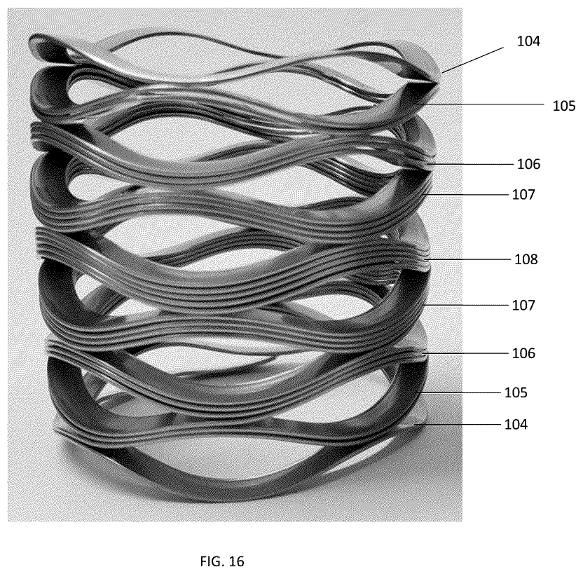

FIG. 16 is an elevational view of a nested crest-to-crest wave spring with different number of turns within different stacks, based on the principles disclosed herein. As shown, a first stack 104 has one turn, a second stack 105 has two turns, a third stack 106 has three turns, a fourth stack 107 has four turns, and a fifth stack 108 has 5 turns. . . . This is a significant improvement over the interlaced wave spring 50, which typically restricts the use of a maximum of three leaves before the spring misaligns or does not function correctly. An advantage of the nested crest-to-crest wave spring is that any stack can have any number of turns as needed, thus making the overall thickness of the stacks to be much thicker than what can be achieved with an interlaced wave spring 50.

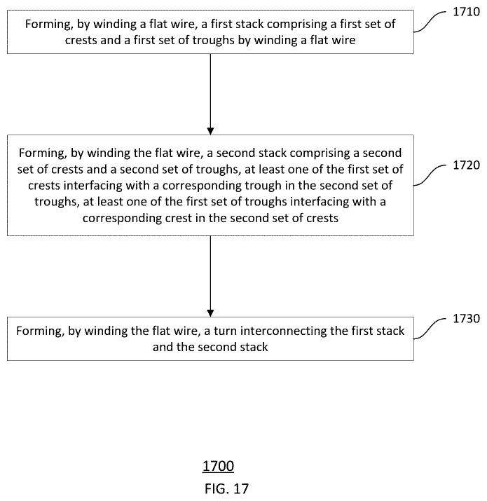

FIG. 17 is a flowchart of an example method 1700 of manufacturing a nested crest-to-crest wave spring, based on the principles disclosed herein. It should be understood that the steps of the method 1700 are merely examples and should not be considered limiting. That is methods with additional, alternative, or fewer number of steps should be considered within the scope of this disclosure.

At step 1710, a flat wire may be wound to form a first stack comprising a first set of crests and a first set of troughs. For example, the first stack may form a top stack of a nested crest-to-crest wave spring.

At step 1720, the flat wire may be wound to form a second stack comprising a second set of crests and a second set of troughs. At least one of the first set of crests may interface with a corresponding trough in the second set of troughs. At least one of the first set of troughs may interface with a corresponding crest in the second set of crests.

At step 1730, the first wire may be wound to form a turn interconnecting the first stack and the second stack. The turn may change the direction of the wave in the first stack by, for example, 180 degrees, before it reaches the second stack.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A nested crest-to-crest wave spring, comprising:
a first stack comprising a first set of crests and a first set of troughs;
a second stack comprising a second set of crests and a second set of troughs, at least one of the first set of crests interfacing with a corresponding trough in the second set of troughs, at least one of the first set of troughs interfacing with a corresponding crest in the second set of crests; and
a turn interconnecting the first stack and the second stack, the first stack, the second stack, and the turn being formed of a single piece of flat wire.

2. The nested crest-to-crest wave spring of claim 1, the turn forming a transition of a 180 degrees between the first stack and the second stack.

3. The nested crest-to-crest wave spring of claim 1, the first stack comprising first number of parallel turns forming the first set of crests and the first set of troughs.

4. The nested crest-to-crest wave spring of claim 3, the second stack comprising second number of parallel turns forming a second set of crests and the second set of troughs.

5. The nested crest-to-crest wave spring of claim 4, the first number of parallel turns being equal to the second number of parallel turns.

6. The nested crest-to-crest wave spring of claim 4, the first number of parallel turns being different than the second number of parallel turns.

7. The nested crest-to-crest wave spring of claim 1, further comprising:
a shim between the first stack and the second stack.

8. The nested crest-to-crest wave spring of claim 7, the shim being flat and circular.

9. The nested crest-to-crest wave spring of claim 1, the first set of crests and the first set of troughs forming a first sinusoidal pattern, and the second set of crests and the second set of troughs forming a second sinusoidal pattern.

10. The nested crest-to-crest wave spring of claim 9, the first sinusoidal pattern and the second sinusoidal pattern being identical.

11. The nested crest-to-crest wave spring of claim 1, the flat wire being formed using a metallic wire comprising at least one of a carbon steel, 17-7 PH stainless steel, Inconel X-750, or Elgiloy.

12. The nested crest-to-crest wave spring of claim 1, the flat wire being formed using a non-metallic wire.

13. A method comprising:
forming, by winding a flat wire, a first stack comprising a first set of crests and a first set of troughs by winding a flat wire;
forming, by winding the flat wire, a second stack comprising a second set of crests and a second set of troughs, at least one of the first set of crests interfacing with a corresponding trough in the second set of troughs, at least one of the first set of troughs interfacing with a corresponding crest in the second set of crests; and
forming, by winding the flat wire, a turn interconnecting the first stack and the second stack.

14. The method of claim 13, forming the turn comprising:
forming a transition of a 180 degrees within the turn and between the first stack and the second stack.

15. The method of claim 13, forming the first stack comprising:
winding the flat wire for a first number of parallel turns forming the first set of crests and the first set of troughs.

16. The method of claim 15, forming the second stack comprising:
winding the flat wire for a second number of parallel turns forming a second set of crests and the second set of troughs.

17. The method of claim 16, the first number of parallel turns being equal to the second number of parallel turns.

18. The method of claim 16, the first number of parallel turns being different than the second number of parallel turns.

19. The method of claim 13, further comprising:
forming a shim between the first stack and the second stack.

20. The method of claim 19, the shim being flat and circular.
